(19) United States
(12) Patent Application Publication
(10) Pub. No.: US 2024/0198558 A1
(43) Pub. Date: Jun. 20, 2024

(54) CUTTING METHOD AND METHOD FOR MANUFACTURING MULTILAYER CERAMIC COMPONENT

(71) Applicant: KYOCERA Corporation, Kyoto-shi, Kyoto (JP)

(72) Inventor: Hisashi SATO, Kirishima-shi (JP)

(73) Assignee: KYOCERA Corporation, Kyoto-shi, Kyoto (JP)

(21) Appl. No.: 18/556,012

(22) PCT Filed: Apr. 6, 2022
(86) PCT No.: PCT/JP2022/017198

§ 371 Date: Oct. 18, 2023

(30) Foreign Application Priority Data
Apr. 23, 2021 (JP) 2021-073688

(51) Int. Cl. B28B 11/14; B26D 1/38; B28B 11/24; H01G 4/30

(52) U.S. Cl. CPC B28B 11/14; B26D 1/385; B28B 11/243; H01G 4/30

(57) ABSTRACT

A multilayer base is placed on a support. The multilayer base is cut by moving a cutting blade including an edge being linear through the multilayer base in a direction parallel to a surface of the support on which the multilayer base is placed. The cutting blade is moved with the edge inclined with respect to a moving direction of the cutting blade.

### TECHNICAL FIELD

The present disclosure relates to a cutting method and a method for manufacturing multilayer ceramic components.

### BACKGROUND OF INVENTION

A known technique is described in, for example, Patent Literature 1.

### CITATION LIST

### Patent Literature

Patent Literature 1: Japanese Unexamined Patent Application Publication No. 2013-162037

### SUMMARY

In an aspect of the present disclosure, a method for cutting a multilayer base includes placing the multilayer base including ceramic green sheets and electrode layers stacked alternately on a support, and cutting the multilayer base by moving a cutting blade including an edge being linear through the multilayer base in a direction parallel to a surface of the support on which the multilayer base is placed. The cutting blade is moved with the edge inclined with respect to a moving direction of the cutting blade.

In another aspect of the present disclosure, a method for manufacturing multilayer ceramic components includes the above cutting method. The manufacturing method includes forming protective layers on surfaces of base components resulting from the cutting, and firing the base components.

### BRIEF DESCRIPTION OF THE DRAWINGS

FIG. 1 is a perspective view of an example multilayer ceramic capacitor.

FIG. 2 is a diagram of a base component before firing.

FIG. 3 is a perspective view of a precursor of the base component.

FIG. 4 is a schematic perspective view of a green sheet on which a conductive paste is printed.

FIG. 5 is a schematic perspective view of stacked green sheets on some of which a conductive paste is printed.

FIG. 6 is a perspective view of a multilayer base.

FIG. 7 is a schematic diagram describing cutting along line VII-VII in FIG. 6.

FIG. 8 is a schematic diagram describing cutting as viewed in a moving direction of a cutting blade.

FIG. 9 is a schematic diagram describing a cutting method according to another embodiment.

FIG. 10 is a perspective view of multiple first rods resulting from cutting.

FIG. 11 is a perspective view of the first rods turned about the axis in the longitudinal direction.

FIG. 12 is a perspective view of the first rods on which protective layers are located.

FIG. 13 is a perspective view of base components resulting from cutting of the first rods.

FIG. 14 is a perspective view of multiple first rods processed with a manufacturing method according to another embodiment.

FIG. 15 is a cross-sectional view of a thermoplastic resin sheet describing its melt.

FIG. 16 is a cross-sectional view of a flat multilayer block.

FIG. 17 is a perspective view of the flat multilayer block.

FIG. 18 is a schematic diagram of the flat multilayer block being cut.

FIG. 19 is a schematic diagram describing cutting as viewed in the moving direction of the cutting blade.

FIG. 20 is a perspective view of multiple second rods resulting from cutting.

FIG. 21 is a perspective view of a component assembly describing its formation.

FIG. 22 is a perspective view of the component assembly describing placement of a ceramic green sheet on the component assembly.

FIG. 23 is a perspective view of the component assembly with the ceramic green sheets.

FIG. 24 is a schematic perspective view of a component assembly after firing.

FIG. 25 is a perspective view of a base component after barrel polishing.

### DESCRIPTION OF EMBODIMENTS

The objects, features, and advantages of the present disclosure will become more apparent from the following detailed description and the drawings.

An example structure that forms the basis of the present disclosure is described in, for example, Patent Literature 1. Recent small and highly functional electronic devices incorporate smaller electronic components. Examples of such electronic components include multilayer ceramic capacitors that typically have a dimension of 1 mm or less on each side. To increase the capacitance per unit volume, the multilayer ceramic capacitors are to increase the area percentage of internal electrode layers by reducing the thickness of dielectric layers between the internal electrode layers and reducing a margin portion for protecting internal components.

A manufacturing method described in Patent Literature 1 includes cutting a multilayer base of ceramic green sheets and conductive films stacked on one another into stacks with conductive films exposed on the cut surfaces. A ceramic paste is applied to the cut surfaces of the stacks to form thin protective portions that serve as margin portions.

In press-cutting described as a manufacturing method in Patent Literature 1, cracks toward the lower surface of a stack can occur in a final process of cutting when a cutting blade approaches the lower surface, causing microcracks on the cut surfaces. With a thinner cutting blade to reduce stress resulting from the cutting blade, the cutting blade may deform outward during cutting, causing the cut surfaces to be irregularly curved and obliquely cut.

A cutting method and a method for manufacturing multilayer ceramic components according to one or more embodiments of the present disclosure will now be described with reference to the drawings. A multilayer ceramic capacitor will now be described as an example multilayer ceramic component. However, the multilayer ceramic component to be manufactured in the embodiments of the present disclosure is not limited to the multilayer ceramic capacitor, and may be any of various other multilayer ceramic components such as multilayer piezoelectric elements, multilayer thermistor elements, multilayer chip coils, and multilayer ceramic substrates.

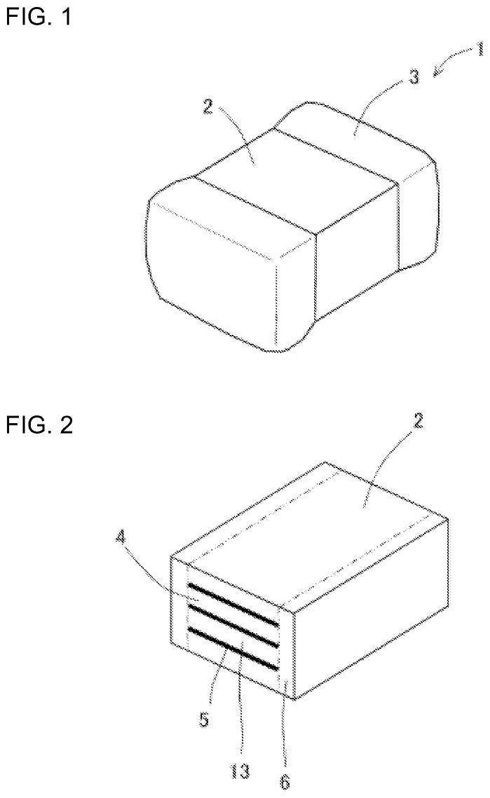

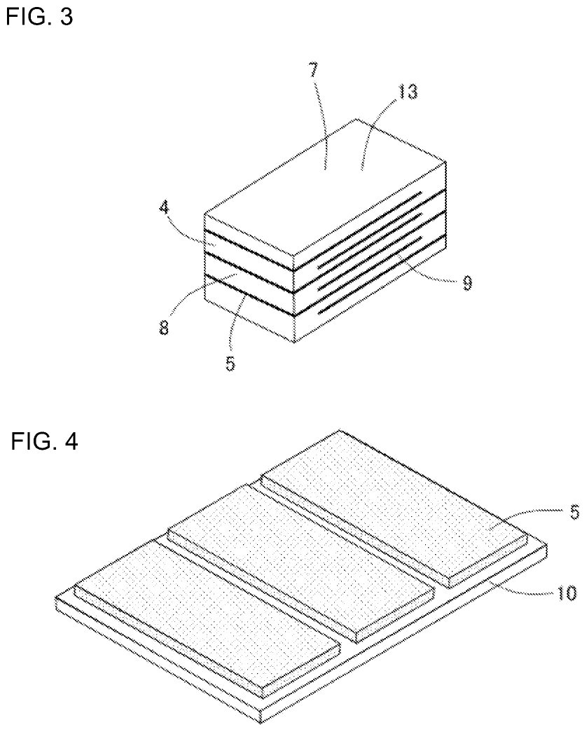

The multilayer ceramic capacitor as an example multilayer ceramic component will be described first. FIG. 1 is a perspective view of an example multilayer ceramic capacitor. FIG. 2 is a schematic perspective view of a base component of the multilayer ceramic capacitor in FIG. 1. FIG. 2 is a diagram of the base component before firing. The base component shrinking after firing has the same structure as before firing. FIG. 2 is thus also a diagram of the base component after firing. FIG. 3 is a perspective view of a precursor of the base component in FIG. 2. The precursor of the base component may be hereafter referred to as a base precursor.

A multilayer ceramic capacitor 1 includes a base component 2 and external electrodes 3. As illustrated in FIG. 2, the base component 2 is substantially a rectangular prism. The base component 2 includes dielectric ceramics 4 and multiple internal electrode layers 5 connected to the external electrodes 3. The external electrodes 3 are located on a pair of end faces of the base component 2 and extend to other adjacent faces. The internal electrode layers 5 extend inward from the pair of end faces of the base component 2 and are alternately stacked without contact with each other.

Each external electrode 3 includes an under layer connected to the base component 2 and a plated outer layer that facilitates mounting of an external wire to the external electrode 3 by soldering. The under layer may be applied to the base component 2 after firing by thermal treatment. The under layer may be placed on the base component 2 before firing and fired together with the base component 2. The external electrode 3 may include multiple under layers and multiple plated outer layers to have an intended function. The external electrode 3 may include no plated outer layer and may include the under layer and a conductive resin layer.

As illustrated in FIGS. 2 and 3, the base component 2 includes a base precursor 13 and protective layers 6. As illustrated in FIG. 3, the base precursor 13 is substantially a rectangular prism. The base precursor 13 includes main surfaces 7 opposite to each other, end faces 8 opposite to each other, and side surfaces 9 opposite to each other.

The internal electrode layers 5 are exposed on the end faces 8 and the side surfaces 9 of the base precursor 13. The protective layers 6 are located on the side surfaces 9 of the base precursor 13. The protective layers 6 reduce the likelihood of electrical short-circuiting between the internal electrode layers 5 exposed on one end face 8 and the internal electrode layers 5 exposed on the other end face 8. The protective layers 6 also physically protect portions of the internal electrode layers 5 exposed on the side surfaces 9 of the base precursor 13. The protective layers 6 are attached in a final process in manufacturing the base component 2. The protective layers 6 protect the internal electrode layers 5 exposed on the side surfaces 9 of the base precursor 13. The protective layers 6 may be made of a ceramic material. In this case, the protective layers 6 may be insulating and have high mechanical strength. The ceramic material to be the protective layers 6 is normally applied to the base precursor 13 before firing. The boundaries between the base precursor 13 and the protective layers 6 indicated by the two-dot-dash lines in FIG. 2 actually appear unclear.

The base precursor 13, which is the precursor of the base component 2, is described above, in addition to the base component 2. The multilayer component in one or more embodiments of the present disclosure includes both the base component 2 and the base precursor 13.

The method for manufacturing the base component 2 in FIG. 2 and the multilayer ceramic capacitor 1 will now be described. A ceramic mixture powder containing a ceramic dielectric material of BaTiO₃ with an additive is first wet-milled and blended using a bead mill. A polyvinyl butyral binder, a plasticizer, and an organic solvent are added to this milled and blended slurry and are mixed together to prepare ceramic slurry.

A die coater is then used to form a ceramic green sheet 10 on a carrier film. The ceramic green sheet 10 may have a thickness of, for example, about 1 to 10 μm. A thinner ceramic green sheet 10 can increase the capacitance of the multilayer ceramic capacitor. The ceramic green sheet 10 may be shaped with, for example, a doctor blade coater or a gravure coater, rather than with the die coater.

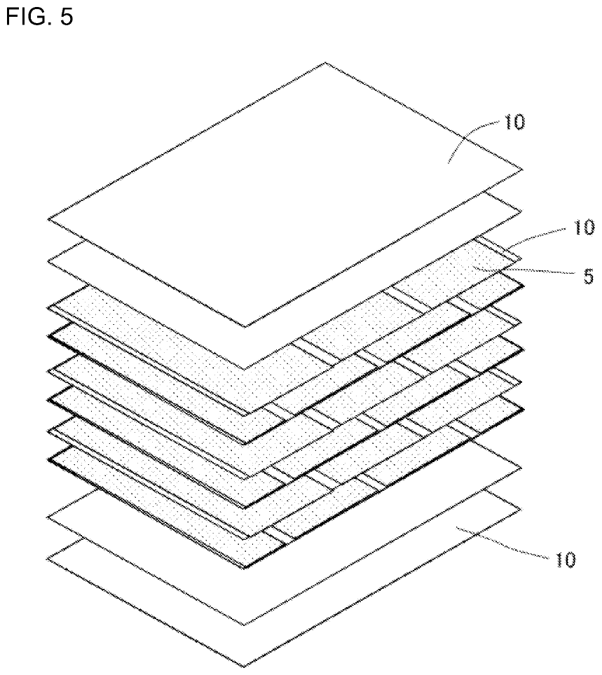

As illustrated in FIG. 4, a conductive paste, which is to be the internal electrode layers 5, is printed in a predetermined pattern by screen printing on the prepared ceramic green sheet 10. The conductive paste may be printed by, for example, gravure printing, rather than by screen printing. The conductive paste may contain a metal such as Ni, Pd, Cu, or Ag or an alloy of these metals. The figure illustrates example internal electrode layers 5 in strip patterns in multiple rows. In some embodiments, the internal electrode layers 5 may be in, for example, an individual electrode pattern.

After printing, the conductive paste is then dried. The solvent content is mainly volatilized by drying. The dried internal electrode layers 5 can contain nickel particles dispersed in an organic binder. Thinner internal electrode layers 5 that allow the capacitor to function can reduce internal defects resulting from internal stress. For a capacitor with a stack of many layers, the internal electrode layers 5 may each have, for example, a thickness of 2.0 μm or less.

As illustrated in FIG. 5, a predetermined number of ceramic green sheets 10 with printed internal electrode layers 5 are stacked on a stack of a predetermined number of ceramic green sheets 10, and a predetermined number of ceramic green sheets 10 are stacked on the stack of ceramic green sheets 10 with the printed internal electrode layers 5. The predetermined number of ceramic green sheets 10 with the printed internal electrode layers 5 are stacked to have the patterns of the internal electrode layers 5 deviating from each other. Although not illustrated in FIG. 5, the ceramic green sheets 10 are stacked on a support sheet. The support sheet may be an adhesive releasable sheet that is adhesive and releasable, such as a low-tack sheet or a foam releasable sheet.

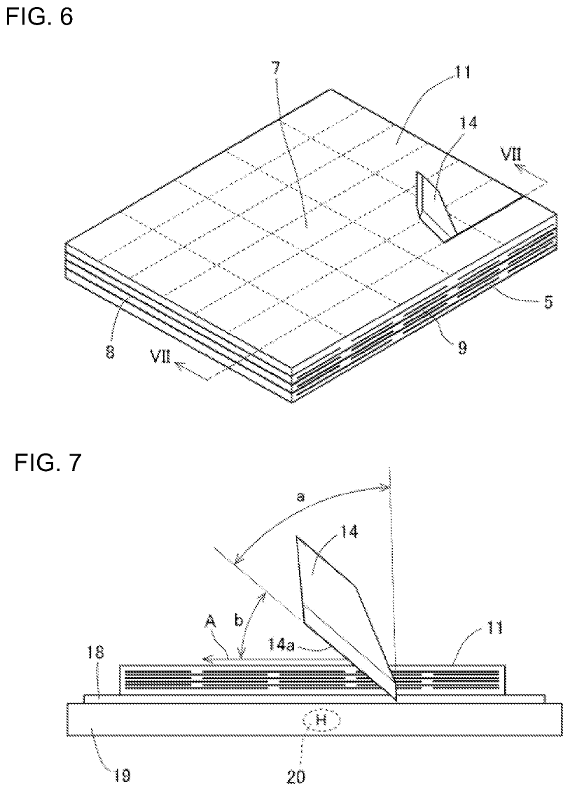

The stack of multiple layers of the ceramic green sheets 10 is then pressed in the stacking direction to obtain an integrated multilayer base 11 as illustrated in FIG. 6. The stack may be pressed using, for example, a hydrostatic press device. In the multilayer base 11, the internal electrode layers 5 are buried in layers between the ceramic green sheets 10. The multilayer base 11 is cut vertically and horizontally to be the base precursors 13 illustrated in FIG. 3. The main surfaces, the end faces, and the side surfaces of the multilayer base 11, corresponding respectively to the main surfaces 7, the end faces 8, and the side surfaces 9 of the base precursor 13, are hereafter denoted with the same reference signs. The broken lines in FIG. 6 are cutting lines indicating the positions for cutting. The multilayer base 11 is cut along the cutting lines using a cutting blade 14. The multilayer base 11 is handled on a support sheet 18 and is also cut on the support sheet 18.

The multilayer base 11 is cut at regular intervals by draw-cutting. FIG. 7 is a schematic diagram describing cutting along line VII-VII in FIG. 6. In the present embodiment, the multilayer base 11 is placed on a support 19, and the cutting blade 14 including an edge 14a being linear is moved through the multilayer base 11 with the edge 14a inclined with respect to a moving direction of the edge 14a to cut the multilayer base 11. The moving direction of the cutting blade 14 is indicated by arrow A in FIG. 7. With the cutting method according to the present embodiment, the cutting blade 14 is moved in a direction parallel to the placement surface of the support 19 on which the multilayer base 11 is placed to cut the multilayer base 11. The moving direction of the cutting blade 14 is along the placement surface of the support 19. When the support 19 is placed with its placement surface parallel to the horizontal direction, the moving direction of the cutting blade 14 is aligned with the horizontal direction. As described above, the cutting method according to the present embodiment includes draw-cutting by moving the cutting blade 14 along the placement surface of the support 19, instead of known press-cutting performed by moving the cutting blade 14 toward the placement surface of the support 19. The multilayer base 11 is typically a flat plate. The multilayer base 11 is thus cut by the cutting blade 14 with its edge 14a inclined with respect to the main surface 7 of the multilayer base 11 when the edge 14a is inclined with respect to the moving direction. The edge 14a of the cutting blade 14 is inclined to cause its upper portion to be at the front of the cutting blade 14 in the moving direction and its lower portion to be at the rear of the cutting blade 14 in the moving direction.

With the cutting method according to the present embodiment, the multilayer base 11 can be cut with a relatively small force, thus reducing stress concentrated on the cut surfaces. This reduces deformation caused by cutting and short-circuiting between the internal electrode layers 5 on the cut surfaces.

In the multilayer base 11, each ceramic green sheet 10 contains a resin binder that can be cut with the cutting blade 14 and ceramic particles dispersed in the ceramic green sheet 10. The ceramic particles cannot be cut with the cutting blade 14. Each internal electrode layer 5 contains, in the same or similar manner as the ceramic green sheet 10, the resin binder that can be cut and metal particles that cannot be cut. In known press-cutting, the edge 14a of the cutting blade 14 is orthogonal to the moving direction. An uncut portion ahead of the edge 14a moving through the ceramic green sheets 10 includes a sparse portion in which the resin binder spreads in the thickness direction of the cutting blade 14 and the ceramic particles are dispersed with low density. The ceramic particles receiving the edge 14a are pressed with the cutting blade 14 in the moving direction without being cut. The pressed ceramic particles are pushed into the uncut portion ahead of the edge 14a. This causes a repulsive force acting to resist cutting. With the cutting method according to the present embodiment, the edge 14a of the cutting blade 14 is inclined with respect to the moving direction, and also the sparse portion with the low density of particles is inclined along the edge 14a. The ceramic particles receiving the edge 14a are pressed with the cutting blade 14 without being cut. At this time, the ceramic particles are obliquely movable along the sparse portion, and thus can deviate from the edge 14a moving toward the ceramic particles. This allows distribution of a repulsive force from the ceramic particles and reduces resistance to cutting. The internal electrode layers 5 are also cut in the same or similar manner as the ceramic green sheets 10. The cutting method according to the present embodiment uses this mechanism to cut the multilayer base 11 with a smaller force than known press-cutting.

Examples of the material used for the cutting blade 14 include carbon steel containing silicon and manganese and cemented carbide resulting from mixing tungsten carbide and cobalt and sintering the compound. The cutting blade 14 may also contain other components to increase hardness, flexural strength, and fracture toughness.

In the present embodiment, for example, the cutting blade 14 is used to cut the multilayer base 11 along one cutting line on the multilayer base 11 and then to cut the multilayer base 11 along an adjacent cutting line. The cutting blade 14 repeats this process until the multilayer base 11 is cut along all the cutting lines.

The tip (edge) of the cutting blade 14 may slide on the placement surface of the support 19. In the present embodiment, moving the cutting blade 14 through the support sheet 18 can reduce damage to the placement surface of the support 19 or wear of the tip of the cutting blade 14.

With the cutting method according to the present embodiment, the edge 14a of the cutting blade 14 and the moving direction have, for example, an angle (inclination angle) b of 15 to 80°. The inclination angle b may be set as appropriate for the thickness and the material of the multilayer base 11.

The cutting blade 14 may include, for example, a pointed tip. The tip of the cutting blade 14 has, for example, an angle of 30 to 75° as viewed in the lateral direction. When the tip angle of the cutting blade 14 is less than 30°, the cutting blade 14 has a smaller thickness and is thus to have an increased thickness to maintain rigidity. When the tip angle of the cutting blade 14 is greater than 75°, the contact area between the cut surface and a blade surface increases and generates a greater frictional force between the cutting blade 14 and the cut surface during cutting. The spine of the cutting blade 14 may be curved or be in the shape of a part of a polygon, or be in any other shape.

The cutting blade 14 may be thinner and may have a longer edge 14a. This allows draw-cutting with a relatively small force. The cutting blade 14 may thus have a thickness of, for example, less than or equal to 100 μm. The cutting blade 14 may be either single-edged or double-edged, but may be double-edged. When the cutting blade 14 is single-edged, the contact area increases between the flat surface of the cutting blade 14 and the cut surface. This generates a greater frictional force between the cutting blade 14 and the cut surface. The cutting blade 14 being double-edged may have the shape of a clam with the cross section of the blade expanding outward. This reduces the contact area between the cutting blade 14 and the cut surface and improves the rigidity of the cutting blade 14.

The support 19 may have a built-in heater 20. The multilayer base 11 on the support 19 is heated with the heater 20 to soften the resin binder in the multilayer base 11. The multilayer base 11 can be easily cut and accommodate deformation during cutting, thus having a smooth cut surface.

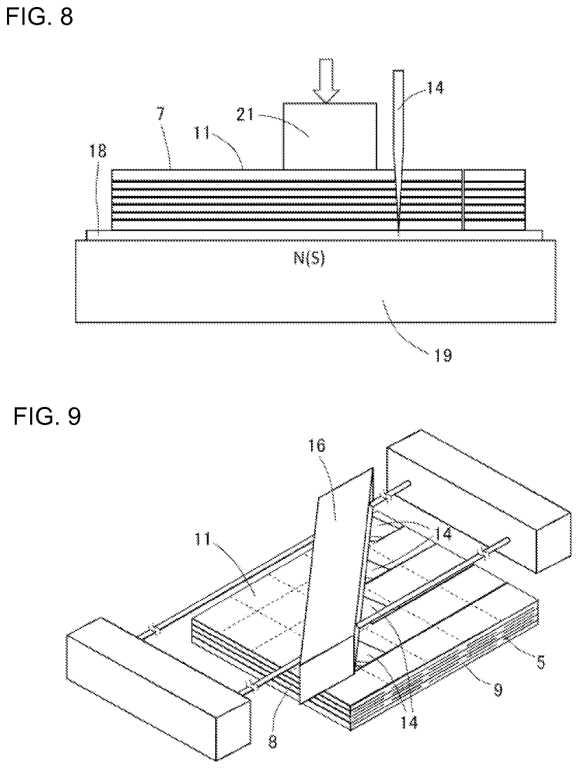

FIG. 8 is a schematic diagram describing cutting as viewed in the moving direction of the cutting blade 14. During cutting, an uncut portion of the multilayer base 11 may be held and fixed between the support 19 and a holding plate 21. The fixed uncut portion is stationary and prevents the cut surface from being irregularly shaped under stress caused by the cutting blade 14 applied to the uncut portion during cutting. A surface on which the holding plate 21 is in contact with the multilayer base 11 may be an uneven surface with a surface roughness Ra greater than or equal to 5 μm. Such an uneven surface can reliably fix the uncut portion.

The support 19 may include a magnet. The magnet may be, for example, an electromagnet. When the cutting blade 14 is made of a magnetic material, such as carbon steel containing silicon and manganese, the tip of the cutting blade 14 is magnetically attracted to the support 19 to prevent the cutting blade 14 from deforming during cutting. When the internal electrode layers 5 in the multilayer base 11 are made of a ferromagnetic material, such as a nickel-containing material, the multilayer base 11 can be magnetically attracted to the support 19 to be fixed during cutting.

Another embodiment will now be described. With the cutting method according to the embodiment described above, cutting is repeated multiple times using one cutting blade 14 to cut the multilayer base 11 along all the cutting lines. In the present embodiment, as illustrated in FIG. 9, multiple cutting blades 14 are held with a holder at regular intervals in a direction orthogonal to the moving direction. The holder is moved to perform cutting. This structure allows a single cutting operation to cut at multiple positions simultaneously.

The cutting blades 14 may be held with a holder 16 that serves as a holder at positions shifted in the moving direction. When cutting is performed simultaneously with the multiple cutting blades 14 aligned in the moving direction, a portion of the multilayer base 11 being cut receives forces generated by two cutting blades 14 in directions opposite to each other and is compressed during cutting. When the cutting blades 14 are held with the holder 16 at small intervals, the cutting blades 14 compress and deform the portion of the multilayer base 11 being cut. The cutting blades 14 may thus be shifted in the moving direction to apply a force generated by one cutting blade 14 to the portion of the multilayer base 11 being cut and reduce deformation under compression. In the example illustrated in FIG. 9, all the cutting blades 14 held with the holder 16 are shifted. Each cutting blade 14 held with the holder 16 may be shifted from adjacent cutting blades 14 in the moving direction. In some embodiments, the cutting blades 14 may be in a staggered arrangement, with every cutting blade 14 being shifted from the adjacent cutting blades 14.

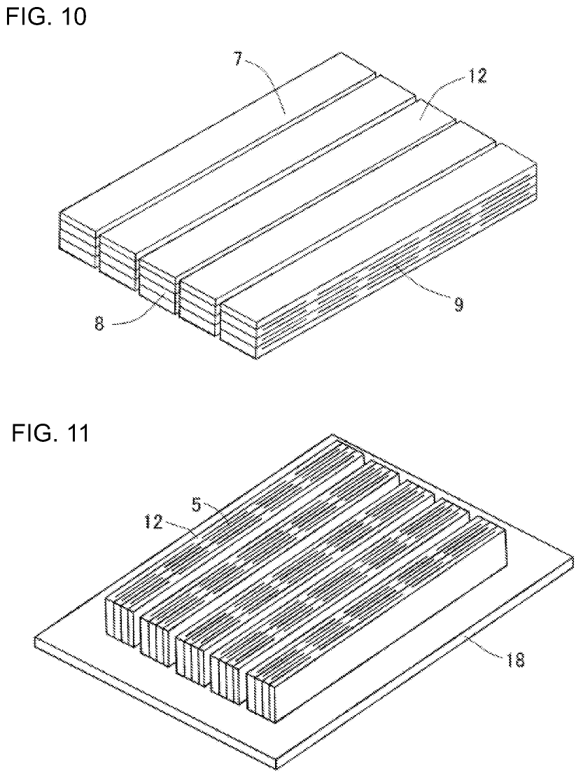

As illustrated in FIG. 10, the multilayer base 11 is cut into multiple first rods 12 with the cutting method according to the present embodiment. Each first rod 12 includes the cut surface corresponding to the side surface 9 of the base precursor 13, and the internal electrode layers 5 are exposed on each cut surface. In one or more embodiments of the present disclosure, the cutting of the multilayer base 11 to obtain the multiple first rods 12 may be referred to as first cutting.

Once the cutting is complete, each first rod 12 is turned by 90° about the corresponding axis in the longitudinal direction to cause the cut surface on which the internal electrode layers 5 are exposed to face upward, as illustrated in FIG. 11.

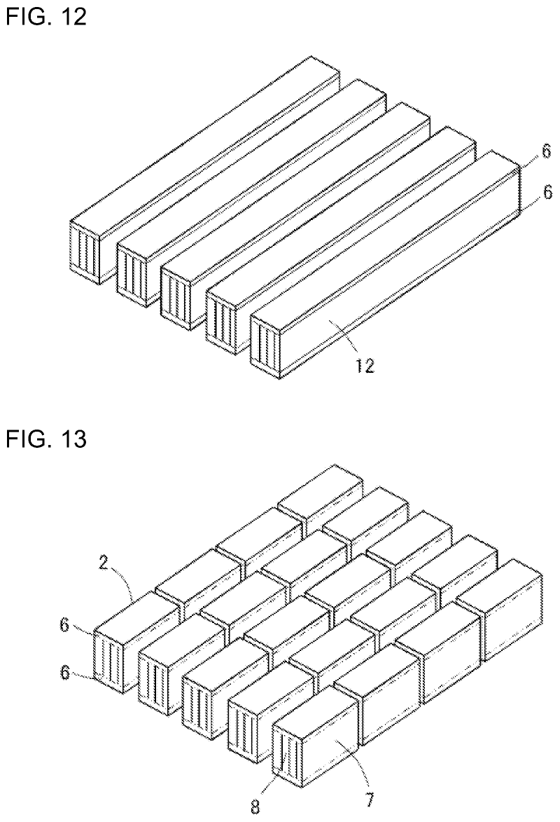

With all the cut surfaces of the first rods 12 facing upward, ceramic slurry can be applied to the cut surfaces of the first rods 12 at a time. After the ceramic slurry is dried, ceramic slurry is also applied to the opposite cut surfaces of the first rods 12 at a time. As illustrated in FIG. 12, the protective layers 6 are formed by applying the ceramic slurry to the cut surfaces of the first rods 12. The ceramic slurry to be the protective layers 6 may have the same component as the ceramic green sheets 10 in the multilayer base 11.

After the protective layers 6 are formed, each first rod 12 is cut into the base components 2 in a direction orthogonal to the first cutting as illustrated in FIG. 13. The base components 2 are then fired. The external electrodes 3 are formed to complete the multilayer ceramic capacitors 1. The firing temperature may be set as appropriate for the dielectric ceramic material contained in the ceramic green sheets 10 to be the dielectric ceramics 4 and the metal material contained in the conductive paste to be the internal electrode layers 5. The firing temperature may be, for example, 1100 to 1250° C.

As described above, the cutting method for the multilayer base 11 reduces deformation caused by cutting and short-circuiting between the electrode layers on the cut surfaces, thus improving the manufacturing yield of the multilayer ceramic capacitor 1.

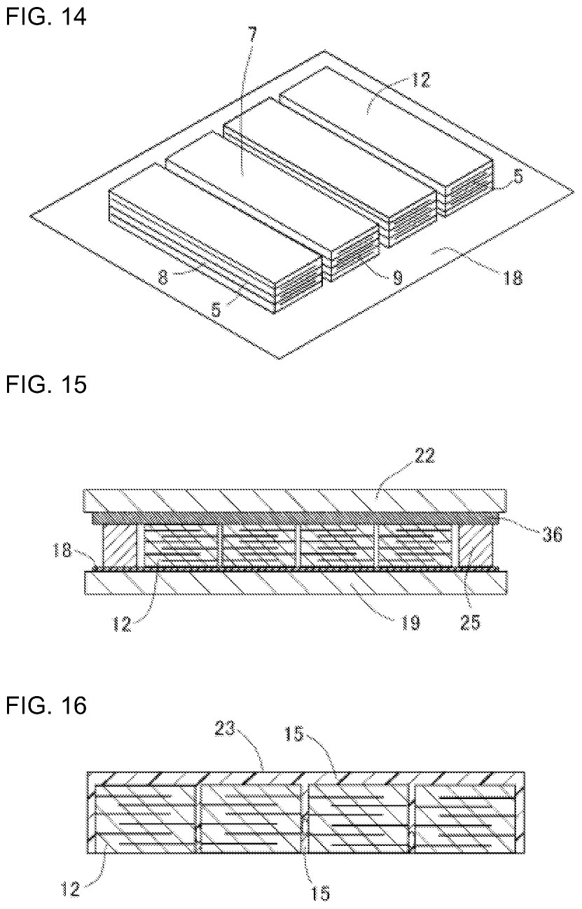

Another method for manufacturing the base component 2 and the multilayer ceramic capacitor 1 will now be described. The method for manufacturing the multilayer base 11 is the same as the method described above, and thus will not be described. The multilayer base 11 is cut into multiple first rods 12 by the first cutting using a cutting machine. Cutting herein may be performed with the cutting method according to the above embodiment or with any other cutting method such as dicing cutting or press-cutting. As illustrated in FIG. 14, with the manufacturing method in this example, the cutting direction of the first cutting differs by 90° from the direction for cutting the first rods 12 described above. The cut surfaces of the first rods 12 in this example correspond to the end faces 8 of the base precursor 13. After cutting, adjacent first rods 12 are spaced regularly.

As illustrated in FIG. 15, a thermoplastic resin sheet 36 and a flat plate 22 are placed to cover the upper surfaces of the multiple first rods 12, and then are heated under pressure. The resin sheet 36 melts upon heating and flows into a gap between the first rods 12. Frame-shaped or columnar spacers 25 are placed on the surface of the support 19 to define the distance between the support 19 and the flat plate 22. The spacers 25 prevent the molten resin sheet 36 from being pushed out by an extra amount by the flat plate 22. A part of the molten resin sheet 36 thus remains on the upper surfaces of the first rods 12.

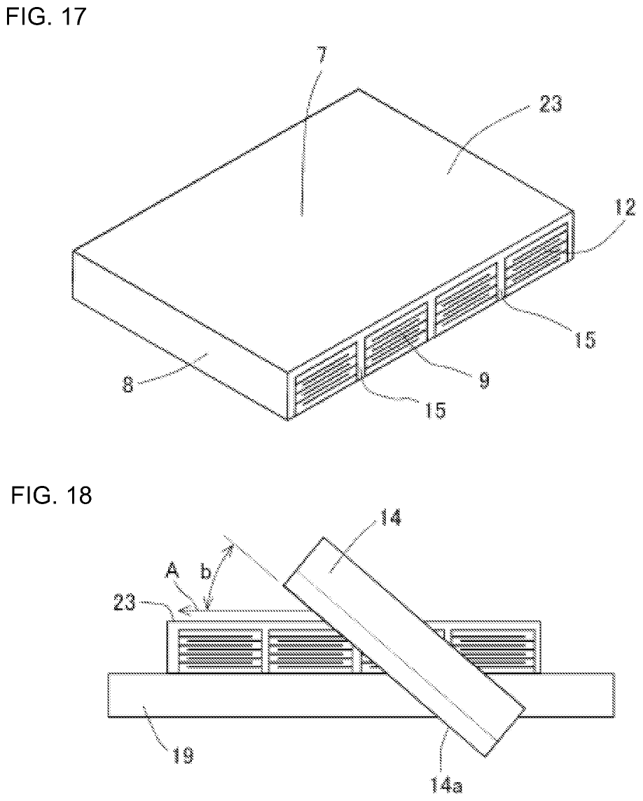

The resin sheet 36 is melted and then cooled to obtain a flat multilayer block 23 with the intervals between the first rods 12 filled with a thermoplastic resin 15 and the upper surfaces of the first rods 12 covered with the thermoplastic resin 15. FIG. 16 is a cross-sectional view of the flat multilayer block 23. FIG. 17 is a perspective view of the flat multilayer block 23. The flat multilayer block 23 is a flat block including the first rods 12 as multiple stacks aligned in the same direction and fixed with a resin.

The flat multilayer block 23 is then cut with the cutting method according to the present embodiment. Cutting herein is performed in a direction orthogonal to the direction of the first cutting. The cut surfaces correspond to the side surfaces 9 of the base precursor 13. As illustrated in FIG. 18, with the same or a similar method as the cutting method described above, the edge 14a of the cutting blade 14 is linear, and the cutting blade 14 is moved with the edge 14a inclined at the inclination angle b with respect to the moving direction. The moving direction of the cutting blade 14 is indicated by arrow A in FIG. 18. When the edge 14a is inclined with respect to the moving direction, cutting is performed with the edge 14a of the cutting blade 14 inclined with respect to the main surface of the flat multilayer block 23. The inclination angle b is, for example, 15 to 80°.

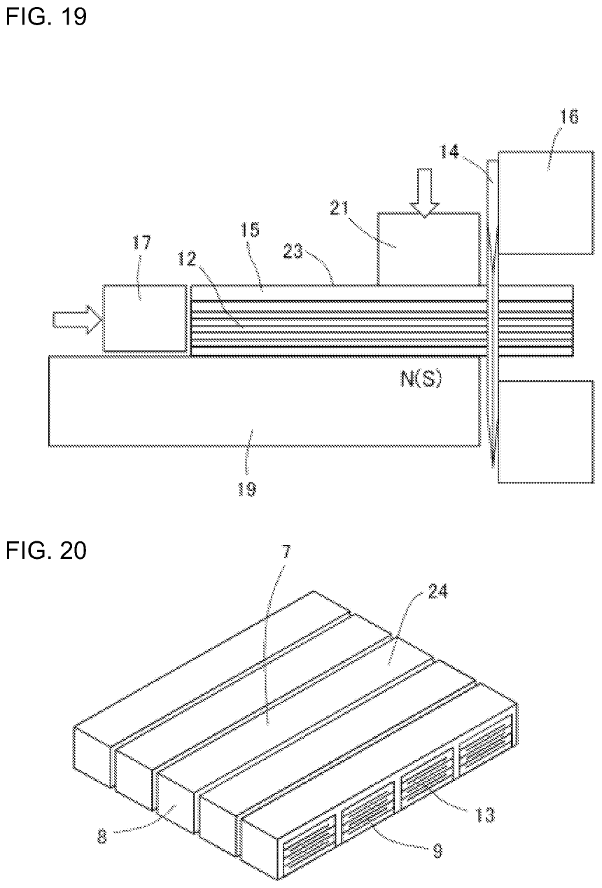

FIG. 19 is a schematic diagram describing cutting as viewed in the moving direction of the cutting blade 14. The vertical ends of the cutting blade 14 are fixed to holders 16 serving as fixing members with the edge 14a inclined. The holders 16 move in synchronization with each other. When the holders 16 move and cut the flat multilayer block 23, the cutting blade 14 is returned to its original position. A pusher 17 then feeds the flat multilayer block 23 to the holders 16 for a predetermined distance for the subsequent cutting.

The flat multilayer block 23 is fixed with the thermoplastic resin 15, and thus is cut with a greater force than for cutting the multilayer base 11. When a relatively great force is used for cutting, the cutting blade 14 does not wobble with both the vertical ends of the cutting blade 14 fixed to the holders 16. This reduces deformation and allows the cut surface to be smooth. During cutting, the uncut portion of the flat multilayer block 23 may be held and fixed between the support 19 and the holding plate 21. The heater 20 may be incorporated in the support 19.

As illustrated in FIG. 20, the flat multilayer block 23 is cut into multiple second rods 24 with the cutting method according to the present embodiment. The cut surfaces of the second rods 24 correspond to the side surfaces 9 of the base precursors 13. Each second rod 24 includes the base precursors 13 connected together with the thermoplastic resin 15.

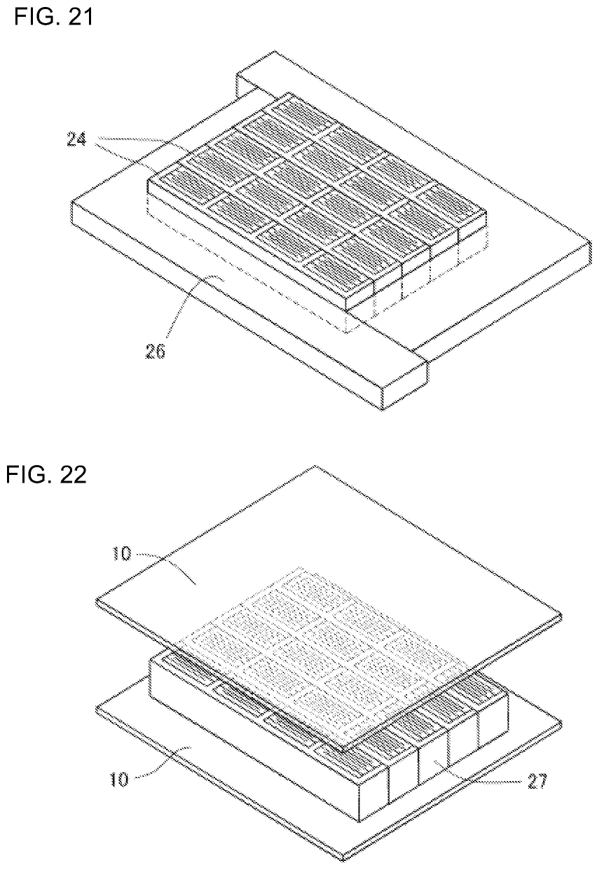

Once the cutting is complete, each second rod 24 is turned by 90° about the corresponding axis in the longitudinal direction to cause the cut surface on which the internal electrode layers 5 are exposed to face upward. The aligned second rods 24 are assembled into a component assembly 27. For example, fixtures 26 are horizontally moved toward the middle from outside the space in the lateral direction. In the perspective view in FIG. 21, the fixtures 26 are L-shaped frames. The second rods 24 are then positioned in the longitudinal direction and a direction orthogonal to the longitudinal direction by the two fixtures 26 to be the flat component assembly 27.

As illustrated in FIG. 22, the ceramic green sheets 10 as the protective layers 6 are then placed on the upper and lower surfaces of the component assembly 27. The ceramic green sheets 10 may be placed simultaneously on the upper and lower surfaces of the component assembly 27. Ceramic green sheets 10 with insufficient strength to be handled alone may not be placed simultaneously on the two surfaces of the component assembly 27, but one such ceramic green sheet 10 may be placed on each surface separately.

The component assembly 27 with its upper and lower surfaces including the ceramic green sheets 10 then undergoes isostatic pressing to tightly bond the ceramic green sheets 10 as the protective layers 6 to the component assembly 27. The component assembly 27 illustrated in FIG. 23 is after removal of excess portions (outer periphery) of the ceramic green sheets 10. In this state, each multilayer ceramic component has the same or similar structure as the base component 2 with the ceramic green sheets 10 placed as the protective layers 6 on the base precursor 13 illustrated in FIG. 3.

The component assembly 27 with the ceramic green sheets 10 undergoes degreasing and firing. The component assembly 27 is first placed on a plate of zirconia. The plate on which the component assembly 27 is placed is then placed in a degreasing furnace to remove the solvent and the binder. The component assembly 27 is then fired in a firing furnace at high temperature. The firing temperature may be set as appropriate for the dielectric ceramic material contained in the ceramic green sheets 10 to be the dielectric ceramics 4 and the metal material contained in the conductive paste to be the internal electrode layers 5. The firing temperature may be, for example, 1100 to 1250° C.

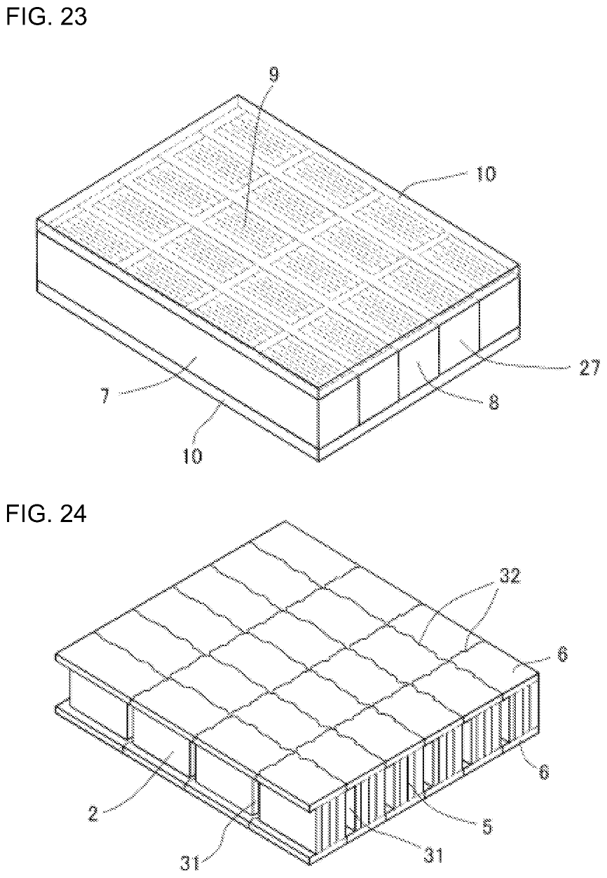

FIG. 24 is a schematic perspective view of the component assembly 27 after firing. As illustrated in FIG. 24, the thermoplastic resin 15 surrounding the base components 2 is decomposed and burned away. This creates voids 31 between the base components 2 at positions previously filled with the thermoplastic resin 15, connecting the base components 2 including the protective layers 6 and the base precursor 13. Separation lines 32 extend in the protective layers 6 along the portions of the voids 31 between the base components 2. This substantially separates the base component 2 individually. During sintering, the base components 2 shrink and have wider gaps between them. This causes cracks in the sintered protective layers 6 between the base components 2 as areas with a reduced thickness, thus forming the separation lines 32.

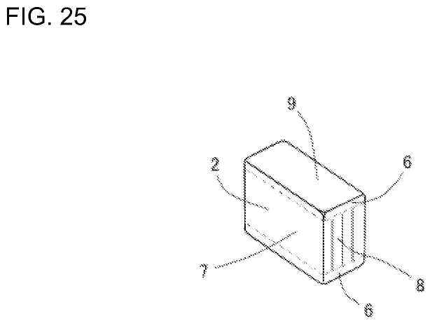

The fired base components 2 undergo barrel polishing. Barrel polishing is performed to round corners and remove burrs on the base components 2. A known barrel polishing method may be used. In the present embodiment, for example, the base components 2 separated along the separation lines 32, and abrasives are placed in a pot of water and rotated for polishing. FIG. 25 is a perspective view of the base component 2 after barrel polishing. As illustrated in FIG. 25, the base component 2 after barrel polishing has no burrs of the protective layers 6 and has the rounded corners.

The base components 2 are obtained in the manner described above. The external electrodes 3 are then formed on each base component 2 to complete the multilayer ceramic capacitor 1.

The cutting method described above reduces deformation caused by cutting and short-circuiting between the electrode layers on the cut surfaces when the flat multilayer block 23 is cut, thus improving the manufacturing yield of the multilayer ceramic capacitor 1.

The present disclosure may be implemented in the following forms.

In one or more embodiments of the present disclosure, a method for cutting a multilayer base includes placing the multilayer base including ceramic green sheets and electrode layers stacked alternately on a support, and cutting the multilayer base by moving a cutting blade including an edge being linear through the multilayer base in a direction parallel to a surface of the support on which the multilayer base is placed. The cutting blade is moved with the edge inclined with respect to a moving direction of the cutting blade.

In one or more embodiments of the present disclosure, a method for manufacturing multilayer ceramic components includes the above cutting method. The manufacturing method includes forming protective layers on surfaces of base components resulting from the cutting, and firing the base components.

With the cutting method according to one or more embodiments of the present disclosure, the multilayer base can be cut with a relatively small force, thus reducing stress concentrated on the cut surface. This reduces deformation caused by cutting and short-circuiting between the internal electrode layers on the cut surface.

The method for manufacturing multilayer ceramic components according to one or more embodiments of the present disclosure improves the manufacturing yield.

The uses of the methods, devices, and materials in the embodiments described above are not limited to the manner in the embodiments alone, and may be combined with one another. For example, the ceramic green sheet or the flat bar assembly with ceramic slurry to be the protective layer may be cut before firing, or the flat bar assembly may be polished and then cleaned. Changing the processing conditions in the embodiments or adding new processes to the embodiments as above does not affect the spirit and scope of the present disclosure.

### REFERENCE SIGNS

1 multilayer ceramic capacitor
2 base component
3 external electrode
4 dielectric ceramic
5 internal electrode layer
6 protective layer
7 main surface
8 end face
9 side surface
10 ceramic green sheet
11 multilayer base
12 first rod
13 base precursor
14 cutting blade
14a edge
15 thermoplastic resin
16 holder
17 pusher
18 support sheet
19 support
20 heater
21 holding plate
22 flat plate
23 flat multilayer block
24 second rod
25 spacer
26 fixture
27 component assembly
31 void
32 separation line
36 resin sheet

1. A method for cutting a multilayer base, the method comprising:
placing the multilayer base on a support, the multilayer base including ceramic green sheets and electrode layers stacked alternately; and
cutting the multilayer base by moving a cutting blade including an edge being linear through the multilayer base in a direction parallel to a surface of the support on which the multilayer base is placed, the cutting blade being moved with the edge inclined with respect to a moving direction of the cutting blade.

2. The method according to claim 1, wherein
the cutting is performed with an uncut portion of the multilayer base held between the support and a holding plate.

3. The method according to claim 1, wherein
the cutting is performed with the multilayer base being heated.

4. The method according to claim 1, wherein
the cutting blade includes a pointed tip.

5. The method according to claim 1, wherein
the support includes a magnet.

6. The method according to claim 1, wherein
a plurality of the cutting blades is located on a holder at intervals in a direction orthogonal to the moving direction, and the cutting is performed by moving the holder.

7. The method according to claim 6, wherein
the plurality of cutting blades is located on the holder at different positions in the moving direction.

8. The method according to claim 1, wherein
the cutting blade includes vertical ends fixed to fixing members, and the fixing members move in synchronization.

9. The method according to claim 1, wherein
the multilayer base is a flat plate including a plurality of stacks aligned in a same direction and fixed with a resin.

10. A method for manufacturing multilayer ceramic components, the method comprising:
the method according to claim 1; and
forming protective layers on surfaces of base components resulting from the cutting, and firing the base components.
